(19) United States
(12) Patent Application Publication
(10) Pub. No.: US 2018/0371643 A1
(43) Pub. Date: Dec. 27, 2018

(54) Method of Identification of Combinatorial Enzymatic Reaction Targets in Glioblastoma Specific Metabolic Network

(71) Applicant: COUNCIL OF SCIENTIFIC & INDUSTRIAL RESEARCH, New Delhi (IN)

(72) Inventors: Ram Rup SARKAR, Pune (IN); Rupa BHOWMICK, Pune (IN); Abhishek SUBRAMANIAN, Pune (IN)

(21) Appl. No.: 15/779,798

(22) PCT Filed: Nov. 30, 2016
(86) PCT No.: PCT/IN16/50425

§ 371 Date: May 29, 2018

(30) Foreign Application Priority Data
Nov. 30, 2015 (IN) 3892/DEL/2015

(51) Int. Cl. C40B 30/02

(52) U.S. Cl. CPC C40B 30/02

(57) ABSTRACT

The present invention relates to an in-silico method for identification of enzymatic reaction targets and combinations thereof useful in cancer therapy. Further, the present invention relates to combinatorial targeting of essential metabolites and reactions associated with glioblastoma survival. The present invention provides a way to prevent or treat glioblastoma by regulating/inhibiting a combination of glycine transporter along with one or more enzymes catalyzing the internal glycine serine metabolism.

### FIELD OF THE INVENTION

The present invention relates to an in-silico method for identification of enzymatic reaction targets and combinations thereof useful in cancer therapy. Further, the present invention relates to the identification of essential metabolites and combinatorial targeting of reactions associated with glioblastoma survival.

### BACKGROUND OF THE INVENTION

Human brain, as a command centre, has to account for highly perplexing conduct which is maintained by interplay between its distinctive cell types, in order to ensure its efficient functioning. An evolving area of interest in the last decade, relating to brain metabolism has been research investigations into the behavioural aspects of astrocytes, their cancerous counterpart glioblastoma and other genetically related factors. The most common and biologically aggressive of malignant gliomas is glioblastoma (GBM), designated by the World Health Organization (WHO) as grade IV gliomas, and is defined by its characteristic features of uncontrolled cellular proliferation, diffused infiltration, propensity for necrosis, robust angiogenesis, intense resistance to apoptosis and rampant genomic instability. Several studies have been performed to understand the metabolic and genetic alterations incurred within astrocytes leading to their phenotypic manifestation as glioblastomas. However, the cumulative effect of individual pathways involved in large scale metabolism, on the functioning of glioblastoma still remain to be answered. The effect of mutual connectivity of individual pathways within its metabolic network and differences in response they show in the astrocytic and glioblastoma scenarios is also largely unknown.

Glioblastoma cells can exhibit a diversified response to the same stimulus and show metabolic heterogeneity, which enables them to thrive even in a glucose starved condition (Griguer, C. E. et al, 2005, Journal of Neurooncology 74, 123-133). A few of the metabolic phenomena like increased accumulation of glycine in glioblastoma cells and disruption of primary brain tumor growth with inhibition of cysteine are known, but the reason to such behaviour is still not understood properly. An early evidence of glycine accumulation to glioblastoma cells was established by. Hattingen, E. et al, in Magnetic Resonance Materials in Physics, Biology and Medicine, 2009 Feb. 1; 22(1):33-41. Knowledge about alternative metabolites, which help glioblastoma cells to survive with altered metabolism, also remains largely unexplored. A large body of varying research investigations have implicated biological phenomena involved in the manifestation of astrocytes into glioblastomas. The Warburg effect in 1924 by Otto Warburg, suggested that cancer cells might adapt to a primitive glycolytic pattern of embryonic cells and mitochondrial injury and metabolic switching of glycolysis to aerobic glycolysis might be essential for cancer development (Warburg, O., 1956, Science 123, 309-14). Studies have been carried out to delineate the advantage of such a modification in tumorous cells. These phenomena are also observable in glioblastoma, enabling them to suffice their rapacious requirements.

Additionally, several other experimental and statistical analyses have been conducted to delineate the phenomenal changes in properties of glioblastoma as an effect of metabolic alterations in different enzymes belonging to different pathways like tryptophan metabolism (Sahm, F et al., 2013, Cancer Research 73, 3225-34), cysteine metabolism (Ye, Z.-C. et al, 1999, The Journal of Neuroscience 19, 10767-777), glutamine and glutamate metabolism (Wise, D. R et al., 2008, Proceedings of the National Academy of Sciences USA 105, 18782-787). The role of these individual metabolic pathways have been studied in both astrocytes and glioblastoma, but the difference in their response as a part of a large metabolic network, in the two scenarios, is yet to be identified.

Genome-scale metabolic reconstructions play a vital role in molecular systems biology as they provide a structured format for genomic, genetic and biochemical information available for a target organism (Barrett, Christian L., et al., 2006, Current opinion in biotechnology 17.5, 488-492). A new arena of in-silico studies have also been employed in the past decade to get large-scale network understanding of glioblastoma. Different types of dynamic modelling approaches, such as spatiotemporal modelling (Burgess, P. K. et al., 1997, Journ. of Neuropathology & Experimental Neurology 56, 704-13 and Tracqui, P et al., 1995, Cell Proliferation 28, 17-31), partial differential equation modelling (Swanson, K. R. et al., 2003, Journ. of the Neurological Sci. 216, 1-10), ordinary differential equations, have been used to detect growth and invasion of glioblastoma cells. These studies, however, provide partial analysis of unanswered questions, and hence, further studies are required to address the same.

A growing body of evidence indicates in-silico methods to identify essential metabolites and metabolic reactions as combinatorial targets in inhibiting and/or treating life threatening diseases such as cancer. Bernard Palsson et al. in U.S. Granted Pat. No. 8,229,673 provides an in-silico model for determining physiological functioning of human cells. Said model disclosed therein includes a data structure comprising a gene database relating to a plurality of Homo sapiens reactants and reactions, a constraint set for the plurality of Homo sapiens reactions, and commands for determining distribution of flux through the reactions that is predictive of a Homo sapiens physiological function. However, said finding aims to only establish the physiological functions of human metabolism and does not identify distinct combinatorial targets to evade or treat diseases.

U.S. Pat. No. 7,788,041 by Rolfsson et al., 2011, BMC systems biology 5.1, 155 provides Homo sapiens Recon 1, a manually assembled, functionally validated, bottom-up reconstruction of human metabolism. Recon 1's 1496 genes, 2004 proteins, 2766 metabolites, and 3311 biochemical and transport reactions were extracted from more than 50 years of legacy biochemical knowledge and Build 35 of the human genome sequence. However, there has been no attempt in US'041 to construct a context specific glioblastoma model using a subset of pathways and their corresponding reactions to determine the range of fluxes that may be used through the involved reactions, and to identify metabolic reaction targets.

Furthermore, the aforementioned modelling methods have been directed to understand the metabolism of glioblastoma in parts, but have not been focused to identify or predict feasible drug targets on a network scale. The utilization of this genome scale model in determining the individual pathway response within the whole network, for estimation of flux profiles through individual reactions and to identify chemotherapeutic targets therefrom, is yet to be done. While genome-scale models aim at including the entire known metabolic reactions, increasing evidence indicate that only a subset of these reactions are active in a given context, including: developmental stage, cell type, or environment (Estévez, Semidán Robaina, and Zoran Nikoloski, 2014, Frontiers in plant science 5, 491). Accordingly, in the present study, a context specific glioblastoma metabolic model has been built, including pathways which are known to get deregulated in the glioblastoma cells. This model is used to determine the role of individual pathways as a part of the metabolic network, the estimation of flux through individual reactions of the network and to determine the essential metabolites for the growth of glioblastoma, and for the prediction of feasible drug targets. The identified drug targets have been further simulated to estimate the range of flux for which each of the target combinations show an effective suppression of glioblastoma growth.

Chemotherapeutic agents are available commercially to treat cancer, having a high degree of target specificity and better clinical manifestation. Gleevec (imatinib), Iressa (gefitinib), Herceptin (trastuzumab), rituximab are a few examples of presently available therapeutics. However, due to multiple genetic and epigenetic alterations, the progression and disease manifestation of cancer turns out to be a complex phenomenon to understand. The malignant cancer cell populations become heterogeneous even within a specific cancer type containing diverse genetic changes, which further alters over time due to genetic instability. A multiple targeting approach in this scenario is favoured over single targets to effectively deal with random mutations generated in a cancer population. Furthermore, the effectiveness of the available therapeutics also has to be monitored, as many of the existing therapeutics are potentially harmful to the normal tissues too and are neurotoxic in nature.

In view of a prevalent requirement to understand the metabolic functioning of glioblastoma and to predict chemotherapeutic targets that may be availed in the treatment of brain cancer, the present inventors have devised a comprehensive constraint based model comprising the varied metabolic pathways involved in glioblastoma functioning to understand the change in metabolic behaviour of astrocytes when converted to glioblastomas, thereby identifying essential metabolites and target reactions to be regulated in the treatment of glioblastoma.

### OBJECT OF THE INVENTION

The main object of the present invention is to provide a method for identifying combinatorial enzymatic reaction targets in a glioblastoma specific metabolic network.

Consequently another object of the present invention is to identify enzymes catalysing the target reactions in metabolic pathways influencing the occurrence of glioblastoma, thereby aiding in cancer therapy.

Another object of the present invention is to provide a comprehensive constraint based model for astrocyte/glioblastoma metabolism to indicate complex differences in the metabolic behaviour of astrocyte and glioblastoma cells and analyse it using a flux distribution method by increasing or decreasing the objective function.

It is yet another object of the present invention to provide combinatorial targets to inhibit glioblastoma survival.

### SUMMARY OF THE INVENTION

The present invention identifies novel combinatorial targets to inhibit glioblastoma growth by employing a comprehensive constraint based in-silico model comprising metabolic pathways implicated in glioblastoma metabolism, and simulating cellular behaviour of astrocytes under varying environmental conditions leading to its physical manifestation into glioblastoma.

In a defining aspect, the present invention provides an in-silico method for identifying essential metabolite and combinatorial target reaction associated with inhibition of glioblastoma cell growth, comprising:
(a) providing data retrieved from biological database and literature relating to reaction in metabolic pathways associated with glioblastoma metabolism to construct an astrocyte/glioblastoma metabolism model in a computer readable storage medium;
(b) simulating the model obtained in step (a) by constraining the fluxes through said reactions in the metabolic pathways as per the reversibility and irreversibility of the reactions, wherein reversible reactions were bound in range of v_{lb}=−1000 and v_{ub}=1000 and for irreversible reactions the model is bound either from 0 to 1000 or 1000 to 0;
(c) defining at least one flux distribution that increases or decreases the objective functions defined for the network, one of which accounts for the ATP requirement of the network and the other comprising ribose-5-phosphate (r5p), oxaloacetate, (oaa), succinate (succ) and glutathione (glt), when a constraint is applied to the astrocyte/glioblastoma metabolism model, wherein said objective functions comprises

(i) ATP synthesis through oxidative phosphorylation (ATPSyn)

ATPSyn=adp[m]+pi[m]+4 h+[i]->h2o[m]+atp[m]+3 h+[m] [Eq. (i)]

(ii) a metabolic demand reaction:

GBM_BM=oaa[m]+glt[c]+r5p[c]+succ[m] [Eq. (ii)];
(d) identifying essential metabolite selected from the group consisting of cysteine metabolism, glycine-serine metabolism, glutathione metabolism, and glycolysis contributing to the increase in objective function, thereby contributing to growth of glioblastoma; and
(e) perturbing the glioblastoma model by performing singleknockout analysis of reactions of step (d) present within the model, and by performing double knockout analysis to identify glycine transporters and/or one or more enzymes catalyzing the reaction of internal glycine-serine metabolism inhibiting glioblastoma growth.

Sole inhibition of each protein and combinatorial inhibition through single and double knockout analyses respectively, yielded a set of single reaction targets and combinatorial targets which could limit the glioblastoma growth.

Sole inhibition of all the reactions belonging to the metabolic network was performed first through single knockout analysis, which yielded reactions such as ribulose phosphate isomerase (RPI), glutamate-cysteine ligase (GCL), glutathione synthase (GS), cystine-glutamate antiporter (Anti_cystine_glut) and cystine reductase (CystRed) to be essential for glioblastoma growth. Combinations of reactions were also tried out to see their inhibitory effects on the glioblastoma proliferation. All possible dual combinations of these reactions were used for this perturbation study while only few of the non-trivial combinations are shown here (FIG. 9). Comparing the results of single knockouts with the double knockouts, it was observed that none of the non-trivial reaction combination was effective enough to suppress glioblastoma growth when targeted individually, but proved to be lethal when knocked out in combinations (FIG. 9). This combination of reaction targets is proposed in this study as the novel and potential drug targets for anti-glioblastoma therapy, which was neither arbitrary nor considered piecewise from existing literature, but came out from the present thorough in-silico perturbation study and model analysis.

In an aspect the present invention provides a process of inhibiting glioblastoma growth by (a) individually targeting reactions belonging to cysteine and glutathione metabolism-Cystine glutamate antiporter or cysteine reductase (CystRed) or Glutamate-cysteine ligase (GCL) or Glutathione synthase (GS), and; (b) combinatorial targeting of the glycine transporter with the reactions of glycine-serine metabolism selected from the group consisting of Phosphoglycerate dehydrogenase (PGDH) or Glycine hydroxymethyl transferase (GHMT) or Phosphoserine phosphatase (PSP) or Phosphoserine transaminase (PST).

In another aspect, the present invention provides glucose and cystine identified to be essential metabolites involved in glioblastoma growth; therefore reactions belonging to cysteine metabolism pathway are indicated to be potential targets for controlling glioblastoma growth. Also, the combinatorial targeting of the reactions belonging to the glycolytic pathway has been implicated.

In one optional aspect, the present invention provides combinatorial targets selected from enzymes catalyzing reactions of glycolysis, glutathione metabolism and pentose phosphate pathway, which may be targeted together with enzymes of cysteine-glutathione metabolism and that of glycine serine metabolism. Accordingly, enzymes to be regulated are selected from the group consisting of α-ketoglutarate dehydrogenase (AKGDH), glucose transporters, glycine transporter, 6-phosphoglucono lactone dehydrogenase (PGCDH), Glucose-6-phosphate dehydrogenase (G6PDH) and Transketolase 1 (TK1).

In yet another aspect, the present invention provides a method of inhibiting glioblastoma by administering a drug or a therapeutic agent that would bind to the metabolic target i.e. an enzyme catalysing the metabolic reactions in the glioblastoma metabolism model.

### BRIEF DESCRIPTION OF THE DRAWINGS

FIG. 1 depicts the classification of the properties of reconstructed metabolic model on the basis of (A) Enzyme commission number or E.C. number, (B) Gene-Non gene association, (C) Cellular compartments and (D) Metabolic processes respectively;

FIG. 2 depicts the validation of Astrocyte scenario;

FIG. 3 depicts the validation of Glioblastoma scenario;

FIG. 4 depicts the effect of Glycine uptake on glutamate utilization by astrocyte;

FIG. 5 depicts the pathway response with maximization of mitochondrial ATP synthase, ‘ATPSyn’ as the objective, wherein the flow of flux through the different reactions of (A) Glycolysis, (B) Pentose phosphate pathway, (C) Cysteine metabolism, (D) Glutamate metabolism, (E) Glycine-serine metabolism and (F) Glutathione metabolism pathway while maximizing mitochondrial ATP synthesis is described;

FIG. 6 depicts the pathway Response with maximization of metabolic function, ‘GBM_BM’ as the objective, through the different reactions of (A) Glycolysis, (B) Pentose phosphate pathway, (C) Cysteine metabolism, (D) TCA Cycle and while maximizing the metabolic function, GBM_BM, for glioblastoma growth;

FIG. 7 depicts the essentiality of metabolites in glioblastoma growth;

FIG. 8 depicts single and double reaction knockout predictions;

FIG. 9 depicts the chemotherapeutic intervention scenarios and effective combination of target reactions. This figure depicts the Percentage reduction of flux through combination of essential double knockout reactions (A) Hexokinase (HEX) and fructose-1,6-bisphoasphate aldolase (FBA), (B) ribulose phosphate-3 epimerase (RPE) and 6-phosphogluconolactonase (6PGLase), (C) fumarate hydratase (FUMH) and alpha ketoglutarate dehydrogenase (AKGDH), (D) glycine transport (Trans_glycine) and Phosphoglycerate dehydrogenase (PGDH), (E) Hexokinase (HEX) and triose phosphate isomerase (TPI), (F) glucose transport (Trans_glucose) and glyceraldehyde-3-phosphate dehydrogenase (GAPDH), (G) phosphofructokinase (PFK) and Hexokinase (HEX), (H) succinyl-CoA synthetase (SCS) and fumarate hydratase (FUMH), (I) ribulose phosphate-3 epimerase (RPE) and glucose-6-phosphate dehydrogenase (G6PDH) and (J) glucose transport (Trans_glucose) and phosphoglycerate kinase (PGK), and its effect on the flux through the metabolic function, GBM_BM (colored region of the contour plot).

### DETAILED DESCRIPTION OF THE INVENTION

The invention will now be described in detail in connection with certain preferred and optional embodiments, so that various aspects thereof may be more fully understood and appreciated.

The present invention provides a comprehensive constraint based in-silico model comprising metabolic pathways implicated in glioblastoma metabolism, and simulating cellular behaviour of astrocytes and glioblastomas under varying environmental conditions leading to its physical manifestation into glioblastoma.

In the most preferred embodiment, the present invention provides an in-silico method for identifying essential metabolites and combinatorial target reactions associated with inhibition of glioblastoma cell growth, comprising:
(a) providing data retrieved from biological databases and literature relating to reactions in metabolic pathways associated with glioblastoma metabolism to construct an astrocyte/glioblastoma metabolism model in a computer readable storage medium;
(b) simulating the model obtained in step (a) by constraining the fluxes through said reactions in the metabolic pathways as per the reversibility and irreversibility of the reactions,wherein reversible reactions were bound in range of vlb=−1000 and vub=1000 and for irreversible reactions the model is bound either from 0 to 1000 or 1000 to 0;
(c) defining at least one flux distribution that increases or decreases the objective functions defined for the network, one of which accounts for the ATP requirement of the network and the other comprising ribose-5-phosphate (r5p), oxaloacetate (oaa), succinate (succ) and glutathione (glt), when a constraint is applied to the astrocyte/glioblastoma metabolism model;
(d) identifying essential metabolites selected from the group consisting of cysteine metabolism, glycine-serine metabolism, glutathione metabolism, and glycolysis contributing to the increase in objective function, thereby contributing to growth of glioblastoma; and
(e) perturbing the glioblastoma model by performing single and double knockout analysis of all reactions present within the model, to identify a combination of glycine transporters and/or one or more enzymes catalyzing the reaction of internal glycine-serine metabolism inhibiting glioblastoma growth.

Sole inhibition of each protein and combinatorial inhibition through single and double knockout analyses respectively, yielded a set of single reaction targets and combinatorial targets which could limit the glioblastoma growth.

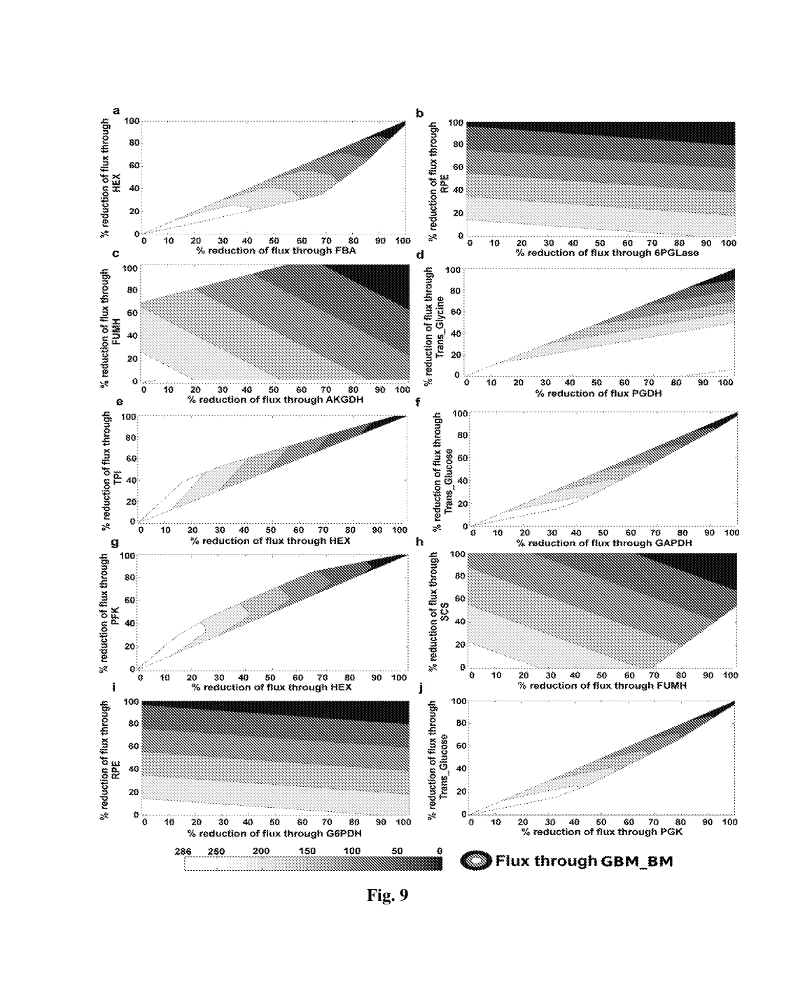

Sole inhibition of all reactions belonging to the metabolic network was performed first through single knockout analysis, which yielded reactions such as ribulose phosphate isomerase (RPI), glutamate-cysteine ligase (GCL), glutathione synthase (GS), cystine-glutamate antiporter (Anti_cystine_glut) and cystine reductase (CystRed) to be essential for glioblastoma growth. Combinations of reactions were also tried out to see their inhibitory effects on the glioblastoma proliferation. All possible dual combinations of these reactions were used for this perturbation study while only few of the non-trivial combinations are shown here (FIG. 9). Comparing the results of single knockouts with the double knockouts, it was observed that none of the non-trivial reaction combination was effective enough to suppress glioblastoma growth when targeted individually, but proved to be lethal when knocked out in combinations (FIG. 9). This combination of reaction targets is provided in the present invention as potential drug targets for anti-glioblastoma therapy, which was neither arbitrary nor considered piecewise from existing literature, but were identified by the present method employed thorough in-silico perturbation study and model analysis.

In accordance with the above preferred embodiment, the present invention provides a glioblastoma metabolism model having a total of 247 reactions, with 39 exchange reactions and 69 transport reactions.

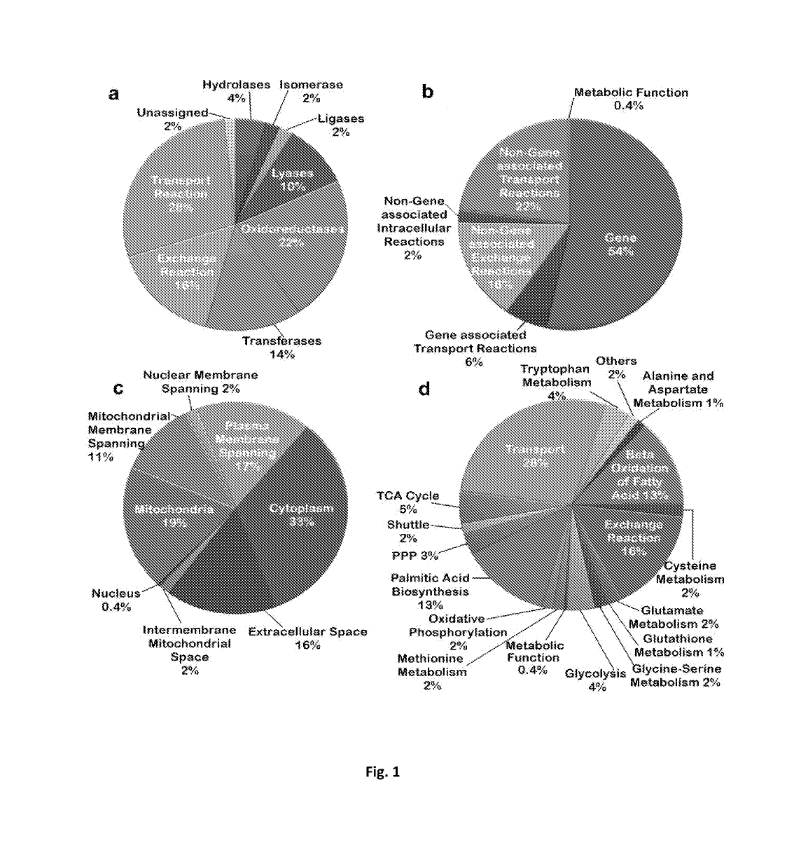

Accordingly, the present invention provides a model for glioblastoma metabolism which is classified on basis of the following four categories: (i) enzyme commission number, (ii) gene non-gene association, (iii) sub-cellular locations, and (iv) metabolic processes (FIG. 1).

Primarily, a large number of the reactions in the present in-silico model are catalysed by enzymes selected from oxidoreductases amounting to 22%, about 14% transferases, about 10% lyases, about 4% hydrolases, about 2% isomerases and about 2% ligases. Another 28% of the reactions belong to transport reactions and 16% to extracellular exchange reactions which occur spontaneously in the present biologic system (FIG. 1A).

Secondly, reactions are also classified on the basis of their association with genes (FIG. 1B). 60% of the model reactions were genetically associated, out of which 6% were transport reactions. The rest of the reactions were classified as: Non-Gene associated Exchange Reactions (16%), Non-Gene associated Intracellular Reactions (2%) and Non-Gene associated Transport Reactions (22%).

Classification according to the sub-cellular localization of reactions is contained in FIG. 1C, cytosolic and mitochondrial reactions contribute to 54% of total reactions in the present model. 2% reactions belong to mitochondrial intermembrane space model compartment that specifically accounted for oxidative phosphorylation. Transport reactions accounted for 30% of the total reactions comprising mitochondrial, nuclear and plasma membrane spanning.

Finally, classification according to metabolic processes indicated 23% reactions belonging to fatty acid metabolism inclusive of biosynthesis and beta oxidation of palmitic acid. The rest of the pathways contribute to 30% of the total count of which 14% constituted Glycolytic, PPP, TCA cycle and Oxidative phosphorylation pathway and 2% were contributed each by Glycine-Serine, Cysteine, Methionine and Glutamate metabolisms, excluding transport and exchange reactions. Another set of reactions, namely, cytosolic ATPase (ATPase), cytoplasmic malate dehydrogenase (MDH(Cyto)), Phosphoenolpyruvate carboxykinase (GTP) (PEP_CarbK_1), mitochondrial pyruvate carboxylase (Pyr_Carbm) which are not assigned strictly under any particular pathway, are categorized as ‘Others’ which contributing to 2% of reactions (FIG. 1D).

In accordance with the above classification, the data relating to reactions involved in the glioblastoma were retrieved from pathway databases, protein data banks, and gene databanks and literature to design a network of pathway reactions, thereby resulting in the formation of the present constraint based model. Said data is assembled into rBioNet extension of COBRA toolbox to reconstruct biochemical reactions, which can be readily converted into mathematical models, and analyzed using constraint-based methods.

Required changes were made to the bounds of certain reactions during simulation of the astrocyte model using flux based analysis (FBA) and the optimal range of bounds within which it showed the properties of astrocyte was estimated.

In an embodiment, the present invention provides a constrained set of fluxes between a lower bound v_{lb} and an upper bound v_{ub}.

All the reversible reactions were bound in the range of v_{lb}=−1000 and v_{ub}=1000. The irreversible reactions in the model were bound either from 0 to 1000 or −1000 to 0 with respect to the substrate and products defined for that reaction as per available information from literature.

In another embodiment, the present invention provides a model astrocyte/glioblastoma scenario, using mitochondrial ATP synthesis (ATPSyn) as the objective function and a metabolic demand reaction (GBM_BM) that dually satisfies growth and ATP requirement.

The metabolic requirement of glioblastoma cells is not completely determined by diverting flux towards ATP production through Oxidative Phosphorylation, which directs toward the requirement of an altered metabolism which satisfies both the energy and metabolic requirement for the growth of the cells, there a metabolic demand reaction is employed.

Accordingly, the objective functions are as follows:

(i) ATP synthesis through oxidative phosphorylation (ATPSyn)

ATP_Syn=adp[m]+pi[m]+4 h+[i]->h2o[m]+atp[m]+3 h+[m] [Eq. (i)]

(ii) Metabolic demand reaction (GBM_BM)

GBM_BM=oaa[m]+glt[c]+r5p[c]+succ[m] [Eq. (ii)]

Specifically, metabolite requirement for the growth of glioblastoma cells is determined by ribose-5-phosphate, r5p(c), oxaloacetate, oaa(m), succinate, succ(m) and glutathione, glt(c)which are included as components of the objective function.

In yet another embodiment, the present invention provides transport reactions associated with corresponding 147 genes in the model.

In another preferred embodiment, the present invention provides (a) targeting of enzymes catalysing reactions of cysteine and glutathione metabolism selected from the group consisting of Cystine glutamate antiporter or cystine reductase (CystRed) or Glutamate-cysteine ligase (GCL) or Glutathione synthase (GS) can suppress glioblastoma growth and; (b) combinatorial targeting of the glycine transporter with the reactions of glycine-serine metabolism selected from the group consisting of Phosphoglycerate dehydrogenase (PGDH) or Glycine hydroxymethyl transferase (GHMT) or Phosphoserine phosphatase (PSP) or Phosphoserine transaminase (PST).

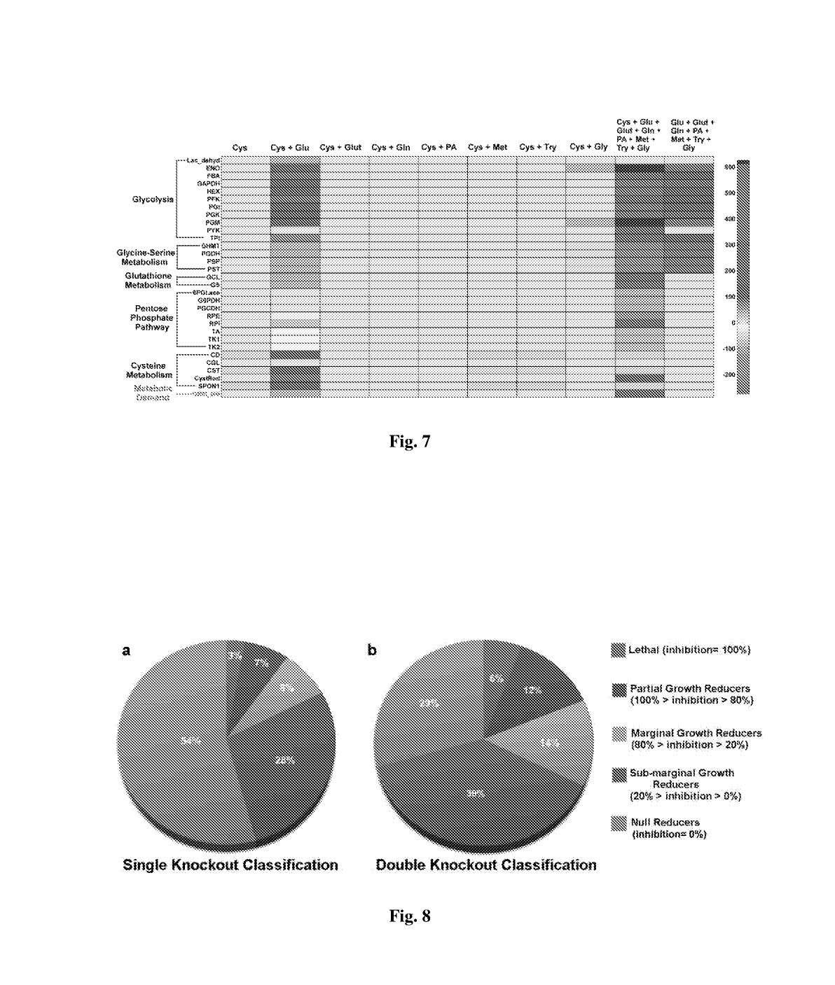

In concurrence with the available experimental evidence, the present model established that cystine was essential for glioblastoma survival and therefore cystine deficiency causes a disruption in glioblastoma growth. Also, effect of glucose in combination with cystine was more pronounced in glioblastoma growth, instead of cystine alone as an input (FIG. 7).

In one embodiment, the present invention provides combinatorial targets selected from enzymes catalyzing reactions of glycolysis, glutathione metabolism and pentose phosphate pathway.

Percentage reduction of flux through combination of essential double knockout reactions Hexokinase (HEX) and fructose-1,6-bisphoasphate aldolase (FBA); ribulose phosphate-3 epimerase (RPE) and 6-phosphogluconolactonase (6PGLase); fumarate hydratase (FUMH) and alpha ketoglutarate dehydrogenase (AKGDH); glycine transport (Trans_glycine) and Phosphoglycerate dehydrogenase (PGDH); Hexokinase (HEX) and triose phosphate isomerase (TPI); glucose transport (Trans_glucose) and glyceraldehyde-3-phosphate dehydrogenase (GAPDH); phosphofructokinase (PFK) and Hexokinase (HEX); succinyl-CoA synthetase (SCS) and fumarate hydratase (FUMH); ribulose phosphate-3 epimerase (RPE) and glucose-6-phosphate dehydrogenase (G6PDH); and glucose transport (Trans_glucose) and phosphoglycerate kinase (PGK); and its effect on the flux through the metabolic function, GBM_BM are determined in FIG. 9.

In one more preferred embodiment, the present invention provides percentage inhibition of glioblastoma tumour cells ranging from about 20% to about 80%, comprising regulating functioning of one or more enzymes of glutamate-cysteine metabolism, glycine-serine metabolism, glycolysis, glutathione metabolism and pentose phosphate pathway.

In yet another preferred embodiment, the present invention provides a method of inhibiting glioblastoma by identifying feasible chemotherapeutic targets/metabolic target i.e. an enzyme catalysing the metabolic reactions in the glioblastoma metabolism model, which could be inhibited using commercially available drugs and other therapeutic agents.

The present invention provides by administering a drug or a therapeutic agent that would bind to the metabolic target i.e. an enzyme catalysing the metabolic reactions in the glioblastoma metabolism model, thereby inhibiting the survival of glioblastoma tumor.

The following is the list of inhibitors to reaction targets including enzyme and transporters identified by the present in-silico method.

TABLE 1

| Sr. No. | Protein Name | Inhibitor Name |
|---|---|---|
| 1 | Alpha-ketoglutarate | CPI-613 |
| | dehydrogenase (AKGDH) | |
| 2 | Hexokinase (HEX) | Lonidamine |
| | | 3-Bromopyruvate |
| | | Imatinib (Gleevec) |
| 3 | Glucose transporter | UDP-glucose |
| | (Trans_Glucose) | N-(4-Azidosalicyl)-6-amido-6- |
| | | deoxyglucopyranose |
| 4 | Glycine transporter | SSR 504734 |
| | (Trans _Glycine) | SSR 103800 |
| | | ORG 25935 |
| | | 2-methoxy-N-{1-[4-phenyl-1- |
| | | (propylsulfonyl)piperidin-4-yl]- |
| | | methyl}benzamide |
| 5 | 6-phosphogluconolactone | 6-Aminonicotinamide |
| | dehydrogenase (PGCDH) | |
| 6 | Glucose-6-phosphate | Imatinib (Gleevec) |
| | dehydrogenase (G6PDH) | 6-aminonicotinamide |
| 7 | Transketolase 1 (TK1) | Oxythiamine |

### EXAMPLES

Following examples are given by way of illustration therefore should not be construed to limit the scope of the invention.

### Example 1

### Reconstruction of the Comprehensive Astrocyte/Glioblastoma Metabolism Model Pathway

In order to construct a network of pathway reactions to understand complex differences in the metabolic behaviour of astrocyte and glioblastoma through a context-specific constraint-based model for astrocyte/glioblastoma metabolism, information relating to the role of metabolic enzymes to crucial biological pathways and internal reactions, their appropriate subcellular locations, transports and exchanges were compiled using a plethora of protein databank sources and pathway interaction databases. Basis of this reconstruction was to identify gene-protein-reaction (GPR) network along with appropriate transport and exchanges. The GPR was reconstructed considering reactions that contribute to ATP synthesis and glioblastoma growth.

The reactions considered in the model and their corresponding Enzyme Commission Numbers (EC Numbers) were retrieved from Expasy Enzyme (Bairoch, A., 2000, Nucleic acids research 28, 304-05) and KEGG (Kanehisa, M., et al., 2014, Nucleic acids research 42, 199-205). Further, genes integral to the enzymatic reactions considered in the model were acquired from the NCBI Gene Bank database. Molecular functioning of these reactions and their biological processes were obtained from UniProt, KEGG through literature survey. Information regarding subcellular localization of reactions was compiled through extensive literature search and those reactions for which literature support for subcellular localization was limited or not available; cytosol was taken to be the default compartment of the reaction. A list of reactions, their corresponding genes, enzymes, UniProt ID and KEGG ID was compiled with appropriate literature support to gather evidences related to biological significance and subcellular localization of reactions. Most of the internal reactions along with 12 transport reactions were associated with their corresponding genes, which accounted for 147 genes in the model. All the metabolites and corresponding reactions in which they were involved were divided into 5 different compartments: Extracellular space, Cytoplasm, Mitochondria, Mitochondrial intermembrane space and Nucleus.

This data gathered was organized in the rBioNet toolbox, a MATLAB extension of the COBRA Toolbox (Schellenberger, 2011, Nature protocols 6, 1290-1307), to reconstruct the constraint-based metabolic model. The reconstructed metabolic network consisted of 13 pathways that are significantly affected during the transformation from astrocyte to glioblastoma and are enlisted below in Table 2. These pathways are retrieved from literature and online databases.

TABLE 2
List of Pathways selected in the Metabolic Reconstruction of
Glioblastoma Scenario and their references.

| No. | Pathways |
|---|---|
| 1 | Alanine and Aspartate Metabolism |
| 2 | Beta Oxidation of Fatty acid |
| 3 | Cysteine Metabolism |
| 4 | Glutamate Metabolism |
| 5 | Glutathione Metabolism |
| 6 | Glycine-Serine Metabolism |
| 7 | Glycolysis |
| 8 | Methionine Metabolism |
| 9 | Oxidative Phosphorylation |
| 10 | Palmitic Acid Biosynthesis |
| 11 | Pentose Phosphate Pathway |
| 12 | TCA Cycle |
| 13 | Tryptophan Metabolism |

### Example 2

### Flux Balance Analysis (FBA)

Flux Balance Analysis is a mathematical approach designed to evaluate flow of metabolites through a metabolic network. In the present invention metabolic reactions were represented in a tabulated form of reaction matrix, of stoichiometric coefficients of each reaction. The present metabolic network indicated a relationship established between metabolites and reactions in the form of an S-matrix which comprised of 159 metabolites and 247 reactions, building up the S-matrix of dimension ‘159×247’. The score assigned to each element of the S-matrix, S_{xy}, represented the stoichiometry of metabolite ‘x’ in reaction ‘y’. A positive score signified production of the metabolite and a negative score implied its consumption in the reaction. The column vector v had 247 fluxes, including 39 exchange reactions and 69 transport reactions. FBA formalizes flux distribution through the whole metabolic network as the dot product of S-matrix with vector v. All reactions in the model were organized in the rBioNet toolbox, where their fluxes were constrained between a lower bound v_{lb} and an upper bound v_{ub}. All reversible reactions were bounded between v_{lb}=−1000 and v_{ub}=1000. The irreversible reactions in the model were bounded either from 0 to 1000 or −1000 to 0 with respect to the substrate and products defined for that reaction as per available information from literature. The bounds to the exchange reactions were fixed as per the requirement of the system for uptake or release of the exchange metabolites. Those exchanges which were known to be taken in were bounded between −1000 to 0 and those which were known to be released out were bounded between 0 to 1000. Rest of the exchanges was bounded between −1000 to 1000 to analyze their role in the metabolism by simulating the model using FBA.

### Example 3

### Selection of Objective Function

The metabolic requirement of the cancerous cells (glioblastoma, in the present case) is not completely sufficed by diverting flux towards production of ATP through Oxidative Phosphorylation, which directs toward the requirement of an altered metabolism which can fulfil both the energy and metabolic requirement for the growth of the cells. Therefore, in the present study, two objective functions were defined:

(i) ATP synthesis through oxidative phosphorylation (ATPSyn)

ATPSyn=adp[m]+pi[m]+4 h+[i]->h2o[m]+atp[m]+3 h+[m] [Eq. (i)]

(ii) a metabolic demand reaction that will dually satisfy the requirements of growth and ATP (GBM_BM). To define the metabolic requirement of the model ribose-5-phosphate, r5p(c), oxaloacetate, oaa(m), succinate, succ(m) and glutathione, glt(c) were included as components of the objective function, selected on the basis of their contribution as (a) precursor to the nucleotide biosynthesis and synthesis of amino acids like valine, lysine, methionine, threonine, etc. (b) intermediates for maintaining redox balance in different cellular compartments and biosynthesis of other cellular components required for cell growth, (c) preventing damage to cellular components caused by reactive oxygen species produced due to hypoxia or other cellular stress:

GBM_BM=oaa[m]+glt[c]+r5p[c]+succ[m] [Eq. (ii)]

### Example 4

### Creation and Validation of Astrocytic and Glioblastoma Scenario

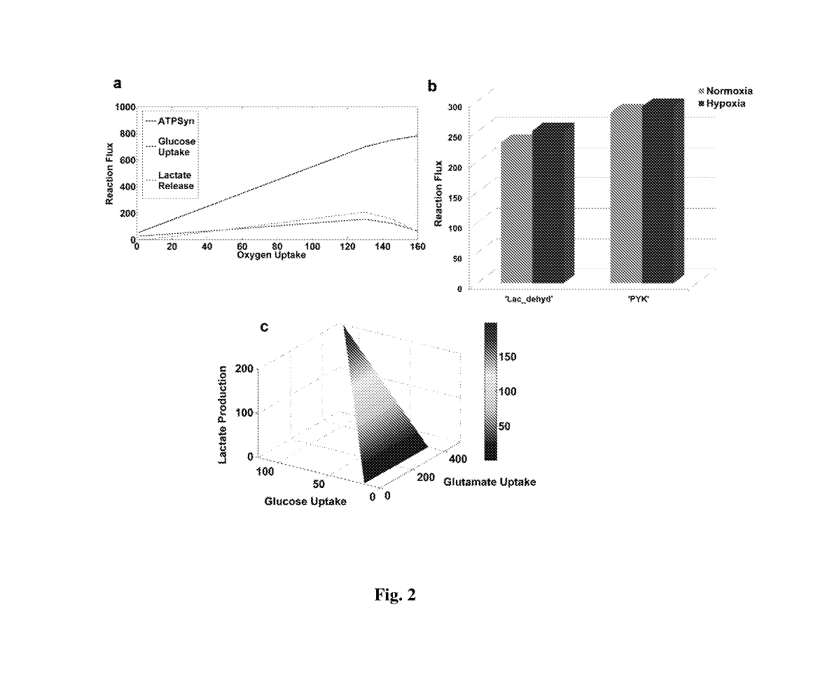

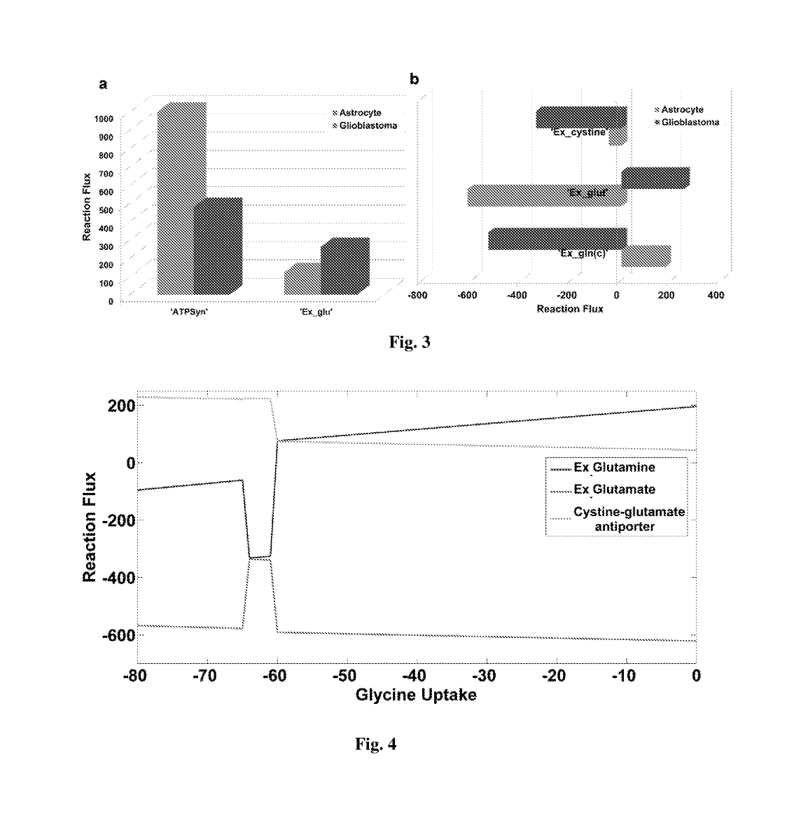

Selected pathways were considered to define the metabolic differences between astrocyte and glioblastoma. Bounds to the flux through a few enzymes which defined the differences between the two scenarios were assigned on the basis of literature support. Both the objective functions were optimized for the two scenarios. Limited bounds were assigned to a few reactions to create the astrocyte scenario. The rest of the reactions fluxes were allowed to vary between a wide range of [−1000 to 1000] or [0 to 1000] or [−1000 to 0] as per the reversibility or irreversibility of the reactions. The model was then simulated to obtain results that were in accordance with the experimentally available data defining the features of astrocyte. Bounds to the mitochondrial reactions—‘glutaminase’ [−50, 50], ‘glutamate dehydrogenase’ [−150, 150], ‘mitochondrial pyruvate carboxylase’ [−10, 10] and cytoplasmic reactions—‘acetyl-CoA carboxylase’ [0, 100], ‘L-carnitine O-palmitoyltransferase’ [0, 20], and ‘cytoplasmic malate dehydrogenase’ [−50, 50], were fixed and the model was analyzed using FBA to create the astrocytic scenario.
(i) Astrocytic Scenario
   Required changes were made to the bounds of certain reactions during simulation of the astrocyte model using FBA and the optimal range of bounds within which it showed the properties of astrocyte was estimated as explained above. The model astrocyte scenario was analyzed and validated, using mitochondrial ATP synthesis (ATPSyn) as the objective function. The astrocyte scenario was validated for a number of experimental observations like pyruvate recycling, lactate production and effect of glutamate.
   The glucose-dependent metabolism where glucose is catabolized to pyruvate that enters the TCA cycle thereby leading to ATP synthesis and partly to the formation of lactate so as to suffice the neuronal requirement of astrocytes was examined in the model astrocytic scenario by performing a robustness analysis of glucose uptake with increasing oxygen uptake. The default flux balance analysis (FBA) in model astrocytic scenario suggested an optimal flux of 160 for oxygen uptake. The uptake of oxygen was thus, varied up to its optimal flux and its effect on glucose uptake was observed. Increase in oxygen uptake led to linear but proportional increase in glucose uptake (FIG. 2A). This inferred the utilization of glucose to produce lactate by the astrocytes without affecting the mitochondrial respiratory chain. Further, above an oxygen uptake of 130, a slight dip in the glucose uptake rate was observed. But simultaneously, flux through mitochondrial ATP synthesis continued to increase, signifying that the decrease in glucose uptake did not affect the ATP synthesis. This was possibly because of the recycling of pyruvate from the TCA cycle intermediates. Reports suggest that TCA cycle intermediate, citrate may give rise to oxaloacetate which is subsequently converted to pyruvate through the activity of malic enzyme or by the combined activity of PEP carboxykinase and pyruvate kinase.
   Similar to this, model simulations suggested recycling of pyruvate by utilization of TCA produced oxaloacetate through PEP carboxykinase and pyruvate kinase reactions. This resulted in a reduced dependence of pyruvate production on glucose uptake. The pyruvate so formed was catabolized into the TCA cycle and compensated for maintaining ATP production proportional to oxygen uptake.
   The activity of lactate dehydrogenase and pyruvate kinase increased during anoxic conditions as compared to normoxic conditions in astrocytes. To verify this property, normoxic and hypoxic conditions were created in the model by constraining the oxygen uptakes at the optimum (flux value=−120) and low (flux value=−2) values and ensuring sufficient glucose uptake in the model. It was observed qualitatively that the model is capable of capturing this feature of astrocytes (FIG. 2B). Although the actual experimental result was generated by incubating the astrocyte cells in a completely oxygen deprived anoxic condition for 6 hours, creating such a situation in the in-silico analysis would lead to zero ATP synthesis (objective function considered for validation) in the model due to its dependence on oxygen. Hence, the property was verified for hypoxic conditions only.
   In astrocytes, the uptake of glucose increases with increase in glutamate uptake thus leading to increased lactate production. This situation was created in the model by regulating the exchanges of glucose, glutamate, glutamine and oxygen. By varying the glutamate uptake from 0 to 450, a corresponding increase in glucose uptake and hence, lactate production was observed during model simulations. Further, it was observed that highest lactate production was at a glutamate uptake flux of 450 (FIG. 2C).
(ii) Glioblastoma Scenario
   Perturbations were done to the same astrocytic model by varying the lower and upper bounds to a few reactions that were experimentally found to be deregulated in glioblastoma, and then the model was simulated to create the glioblastoma scenario. Bounds were released to a few reactions, which were imposed in the astrocytic scenario: ‘glutaminase’ [−1000, 1000] and ‘acetyl-CoA carboxylase’ [0, 1000]. New bounds were assigned to another set of reactions to generate the glioblastoma scenario: ‘glutamate dehydrogenase’ [−200, 200], ‘Cytochrome c Oxidase (complex IV)’ [−10, 10], ‘Trans_Glutamate (ATP)’ [−90, 90] and ‘glycine exchange’ [−500, 500]. This model was analyzed using both ‘ATPSyn’ and ‘GBM_BM’ as objective function. This model was again validated with experimental data available for glioblastoma.
   A separate metabolic demand reaction was also introduced in the model glioblastoma scenario so as to understand the influence of different metabolites on glioblastoma growth. Considering this reaction as the cellular objective, the glioblastoma scenario was further studied for its metabolic properties. All the further analyses have been performed keeping the GBM_BM metabolic demand reaction as the objective function. For verification of the objective function—‘GBM_BM’ in representing the properties of glioblastoma, a qualitative analysis was performed to compare the activity of certain reported reactions in astrocytic and glioblastoma scenario. The fold change in activity from astrocytic to glioblastoma scenario as predicted from the model was compared to existing proteome data extracted from young glioblastoma patients. The results of this comparison are listed in Table 3. Data was available as fold change in expression for eight reactions of the model. Out of the eight reactions, predicted activity for five reactions was qualitatively found to be in correspondence with the experimental observations.

TABLE 3
Comparison of model prediction with the data available for enzyme expression in young patients

| Uniprot | | Model | Fold | Model | Gene | Fold | Experimental |
|---|---|---|---|---|---|---|---|
| ID | Reaction name | abbreviation | Change | Prediction | abbreviation | Change | prediction |
| O43175 | D-3-phosphoglycerate | PGDH | 0.9313 | D | PHGDH | 0.55 | D |
| | dehydrogenase | | | | | | |
| P04075 | Fructose-bisphosphate | FBA | 0.9175 | D | ALDOA | 0.71 | D |
| | aldolase A | | | | | | |
| P50213 | Isocitrate dehydrogenase | IDH | 0.0000 | D | IDH3A | 0.48 | D |
| | [NAD] subunit alpha, | | | | | | |
| | mitochondrial | | | | | | |
| P18669 | Phosphoglycerate mutase 1 | PGM | 2.4046 | U | PGAM1 | 1.6 | U |
| Q9Y617 | Phosphoserine | PST | 0.9313 | D | PSAT1 | 0.53 | D |
| | aminotransferase | | | | | | |
| P00367 | Glutamate dehydrogenase, | GlutDH | 0.0000 | D | GLUD1 | 1.4 | U |
| | mitochondrial | | | | | | |
| P60174 | Triosephosphateisomerase | TPI | 0.7401 | D | TPI1 | 2.1 | U |
| P17174 | Aspartate | ASPTc | 1.0732 | U | GOT1 | 0.53 | D |
| | aminotransferase, | | | | | | |
| | cytoplasmic | | | | | | |

Regulation in enzymatic expression (up-regulation or ‘U’ and down-regulation or ‘D’) for eight reactions of the present in-silico model could be related to the enzymatic profile available for young glioblastoma patients.

### Example 5

### In-Silico Prediction of Minimal Essential Metabolite for Glioblastoma Growth

Glioblastoma cells are grown in commercially available MEM or DMEM media. However, due to lack of sufficient literature that reported essential metabolites required for glioblastoma growth even at glucose starved conditions, an in-silico simulation was performed to check the fate of certain key metabolites that contribute to cell growth in glioblastoma. Glioblastoma cell lines can exhibit prolonged sustenance under glucose starved conditions by undergoing physiological adaptations to utilize nutrient alternatives and thus, combat deprivation. In order to determine those metabolites which essentially contributed to glioblastoma survival, even at glucose starved conditions, the metabolic fate of eight carbon sources namely, glucose, cystine, methionine, tryptophan, palmitate, glutamate, glutamine, and glycine through the network, was investigated. The entry of each carbon source was considered in the model, one at a time and the corresponding solution of the GBM_BM objective function (growth) was computed. Also, the fate of the most essential metabolite with another input carbon source within the model was checked and the optimal solution of the GBM_BM objective was calculated. This was performed to identify the most important carbon sources required for enhancing glioblastoma growth.

Although, glucose was largely required for satisfying metabolic demand and for increasing glioblastoma growth rate, it was evident from simulation results that cystine was found to be an essential metabolite for glioblastoma growth. A complete deprivation of glucose did not lead to zero growth although a considerable reduction in growth rate was observed; this finding was in accordance with previous research investigations. In parity with the available experimental evidence, the model yielded that cysteine was essential and cystine deficiency might cause a disruption in the glioblastoma growth. Also, effect of glucose in combination with cystine was more pronounced in glioblastoma growth, instead of cystine alone as input (FIG. 7). The simultaneous uptake and utilization of cystine and glucose served as the minimal metabolite requirement that could drive all those pathways which lead to synthesis of objective function components [Eq. (ii)]. The essential role of cystine is to produce glutathione that would be required to combat oxidative stress. And the role of glucose was to produce ribulose-5-phosphate, oxaloacetate and succinate through PPP and TCA cycle. Consequently, this minimal combination resulted in a solution higher than any other combination, thereby accounting for optimal glioblastoma growth. Restricting the uptake of either of these metabolites led to either zero growth or a highly reduced growth rate (<20% of the optimal value).

### Example 6

### Single and Double Reaction Knockouts in Glioblastoma

A reaction knockout strategy was chosen, instead of gene knockout approach, to completely nullify the functional effect of the reaction in the network. Reaction knockout predictions allowed the identification of reactions that could be targeted for either completely inhibiting or reducing the glioblastoma growth.

As provided in Example 5, cystine was found to be the essential metabolite influencing glioblastoma growth. In order to determine the essentiality of the reactions involved in the metabolism of cystine, and also to find other important reactions in the model, which could be targeted for reducing glioblastoma growth, single and double reaction knockout analyses were performed. All the single and double reaction knockout results were categorized as cases of lethal, trivial and non-trivial lethal and non-trivial solutions.

Each of the 247 reactions in the metabolic network was knocked down individually to predict the mutations that could be lethal to the glioblastoma growth. For performing the knockout, flux through each reaction in the network was constrained to zero and solution of the GBM_BM objective function was computed for each knockout. Double reaction knockouts were also performed, with a combination of two reactions to be knocked down simultaneously. The single and double knockouts were classified on the basis of percentage reduction of flux through the objective function, GBM_BM, from its optimal value, the results are provided in the below Table 4. The optimal value of the objective function for the astrocytic scenario in the model corresponded to the normal growth rate.

Glioblastoma cells can thrive on different metabolic pathways for survival and show great metabolic heterogeneity. In parity to this, it was observed that around 3% (6 reactions) of the total single knockouts (208 reactions) and 6% (1268 reactions) of the total double knockouts (21528) were lethal to the glioblastoma scenario. A low number of lethal single knockouts suggested the robustness of metabolism in sustenance of the glioblastoma cells through alternative routes. Knockout analysis was performed on the network using GBM_BM as the objective function.

TABLE 4
Total number of single and double lethal reaction knockouts.

| | | Trivial | Non-trivial | Non-trivial | |
|---|---|---|---|---|---|
| Deletion | Lethal | Lethal | Lethal | Total | Total Cases |
| Single | 6 | NA | 6 | 208 | 208 |
| Double | 1268 | 1227 | 41 | 20301 | 21528 |

Knockout analysis identified ribulose phosphate isomerase (RPI), a part of pentose phosphate pathway to govern a lethal phenotype. In many type of cancers, it has been experimentally observed that Pentose Phosphate Pathway (PPP) drives the glycolytic flux for production of ribose-5-phosphate and NADPH that can be used by cancer cells for detoxification of reactive oxygen species. RPI represents a rate limiting-step for ribose-5-phosphate production in PPP pathway. As ribose-5-phosphate is an essential component to meet cellular metabolic demand, RPI was predicted to govern a lethal phenotype in glioblastoma scenario. Also, in different types of cancers, high levels of glutathione content have been experimentally observed to combat oxidative stress experienced by cancer cells. Glutamate-cysteine ligase (GCL), rate-limiting step for production of glutathione was predicted to govern a lethal phenotype as it is the penultimate step for glutathione production. Similarly, glutathione synthase (GS), the ultimate step of glutathione synthesis from glutamate and cysteine was also predicted to govern a lethal phenotype. The cystine-glutamate antiporter (Anti_cystine_glut) and cystinereductase (CystRed) reactions are involved in production of cysteine. In the previous results, it was demonstrated that cystine was sufficient for production of components of the GBM_BM objective. Hence, both reactions were predicted to demonstrate lethality when knocked out.

Of the 1268 lethal double knockout reactions, 41 were non-trivial, which included reactions from glycolytic, pentose phosphate, TCA cycle and glycine-serine metabolism pathway and a few transport reactions. The most typical observation of glioblastoma metabolism through experiments was increased flux through glycolysis for a high production of ATP and corresponding reduction in glioblastoma growth under glucose starvation, even though their survival was maintained. A combinatorial targeting of the glycolytic pathway with PPP, TCA cycle and glycine-serine metabolic pathways was hence, found to be more effective in combating glioblastoma growth. Thus, knockdown of a glycolytic pathway reaction in combination to a pentose phosphate pathway reaction or a TCA cycle reaction hindered production of r5p or oaa or succ. Consequently, the double knockouts proved to be lethal to the glioblastoma growth. The in-silico results also yielded reactions belonging to glycine-serine metabolism as good targets in combination with each other. Glycine was necessarily required for glutathione production. When availability of glycine was blocked through knockdown of both internal glycine-serine metabolism and the external source of glycine uptake, this paired knockout led to the production of glutathione, and hence proved lethal. Consequently, dual targeting reactions of this pathway were effective in reducing glioblastoma growth.

The knockouts reaction results were further classified as lethal, growth reducers and null reducers on the basis of percentage inhibition in the metabolic demand reaction rate in the glioblastoma scenario (FIG. 8). Knockouts which led to 100% inhibition of metabolic demand reaction were considered to be “Lethal”. Reaction knockouts which caused a flux reduction of greater than 80% of the flux through the metabolic demand were considered to be “Partial growth reducers”. Those set of reaction knockouts which inhibited the flux of metabolic demand within 20% to 80% of the default value, were considered as “Marginal growth reducers”. The class of ‘sub-marginal growth reducers’ was considered for those set of knockouts which could not bring effective reduction (0% to 20% inhibition) through the objective function. Analysis of the double knockout showed that 48% of the partial growth reducers belonged to the glycolytic pathway. The rest of the 52% were mostly constituted by the reactions of TCA cycle, PPP, Oxidative phosphorylation and Glycine-serine metabolism. The larger fraction of both single and double reaction knockouts which belonged to sub-marginal growth reducers and null reducers which were indicative of the robust and redundant reactions of the glioblastoma metabolic network.

### Example 7

### Difference in Pathway Response Between the Astrocytic and Glioblastoma Scenarios

Cells tend to either maximize ATP synthesis or optimally use metabolites from the environment to satisfy their cellular demand for optimum growth. The choice of an objective function that can be used to capture actual biological scenarios is a primary requirement for performing FBA. To understand the roles of cellular objectives, the model was simulated in both the astrocytic and glioblastoma scenarios for the two objective functions: mitochondrial ATP synthesis and GBM_BM metabolic demand reaction separately.

Maximization of Mitochondrial ATP Synthesis

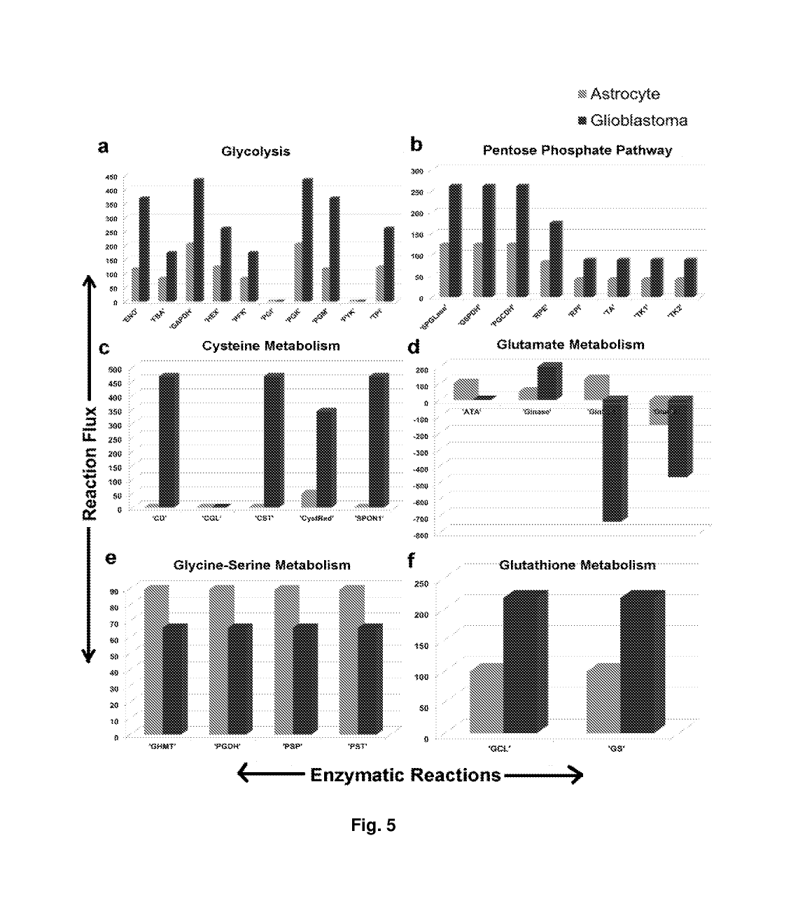

FBA simulations for maximization of ATP synthesis revealed a number of metabolic features of the glioblastoma scenario.
i) Increase in Glycolytic Flux in Glioblastoma:
   Simulations for ATP synthesis as the objective function demonstrated a significant increase in the flux through the glycolytic and pentose phosphate pathways in the glioblastoma scenario as compared to the astrocyte but a corresponding decrease in ATP synthesis (FIGS. 5A and B). To create the glioblastoma scenario, a reduced activity of Complex IV of the electron transport chain was assumed. ATP synthesis is largely dependent on Complex IV for redox balance. Hence, decreased ATP synthesis is observed. Under the reduced activity of Complex IV, the deficiency of electrons for ATP synthesis is partly met through Complex I and III of electron transport chain. This led to an increased synthesis of oxaloacetate from phosphoenolpyruvate through the PEP carboxykinase and aspartate aminotransferase reactions. Hence, flux through glycolysis is largely increased in the glioblastoma scenario for the provision of phosphoenolpyruvate. The glycolytic dependence of ATP synthesis is a unique feature of glioblastoma cells that could be captured from the model.
ii) Increase in Cystine Uptake in Glioblastoma:
   Simulations for ATP synthesis as the objective function also demonstrated an increased uptake of cystine (FIG. 5C). The total flux of cystine is distributed into cysteine biosynthesis which is then distributed towards a relatively low amount of glutathione biosynthesis (FIG. 5F) and largely towards production of pyruvate through the cysteine dioxygenase (CD), cysteine sulfinate transaminase (CST), and the spontaneous 3snpyr (SPON1) reactions. This pyruvate is utilized for acetyl coA synthesis and hence, biosynthesis of fatty acids which are further released in the extracellular environment.
iii) Increased Catabolism of Glutamine in Glioblastoma:
   Reactions belonging to glutamate metabolism showed a higher activity which was due to higher glutaminolysis in glioblastoma scenario. This was due to uptake of glutamine by glioblastoma cells, from external medium, which was converted to glutamate within the cell. Glutamate that was formed was mostly used by the cystine-glutamate antiporter (anti_cystine_glut) in order to uptake cystine. Cystine then is utilized in the cysteine metabolism pathway for pyruvate synthesis that enters TCA cycle (FIG. 5D).
iv) Decreased Glycine-Serine Biosynthesis in Glioblastoma:
   Simulations for ATP synthesis as objective function demonstrated an increased glycine uptake (FIG. 5E). It could be observed that glycine was preferred to be taken into the cell as compared to being synthesized as seen in astrocyte. This was because glycolytic flux instead of being distributed into mitochondrial TCA cycle and glycine-serine metabolism was completely utilized into TCA cycle for maximizing ATP production.

Maximization of the Objective Function

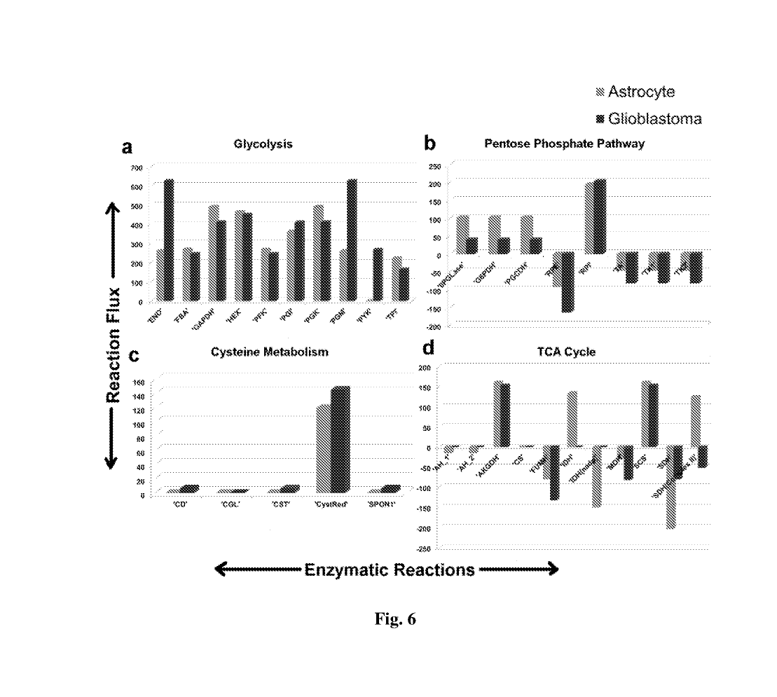

Qualitatively, the same trend of pathway response was observed for the two scenarios while optimizing the model for the metabolic demand reaction ‘GBM_BM’. Although, a few more differences was further observed while considering the GBM_BM demand reaction.
i) Increased flux through glycolysis and pentose-phosphate pathway in glioblastoma: Simulating the model for GBM_BM objective function in both the scenarios suggested an increased flux through the glycolysis and pentose-phosphate pathway (PPP) reactions (FIGS. 6A and B). This increased flux is contributed by the glycine uptake through the phosphoglycerate dehydrogenase (PGDH) reactions into glycolysis and hence, PPP so as to provide for ribulose-5-phosphate present in the GBM_BM objective. Further, the lower part of glycolysis was observed to be more active as compared to the upper reactions as reported in a study where a low activity of hexokinase was observed due to the loss of chromosome 10. Apart from this, some amount of glycine is partly distributed through the phosphoenolpyruvate carboxykinase (PEP_CarbK_1) reaction for production of oxaloacetate and succinate which is part of the GBM_BM demand reaction.
ii) Increased cystine uptake in glioblastoma: Simulating the model for GBM_BM objective function in both the scenarios further demonstrated a higher increase in cystine uptake and its metabolism as compared to the model simulations using ATP synthesis as objective (FIG. 6C). This was because of the higher requirement of glutathione to meet the metabolic demand of glioblastoma cells to combat oxidative stress.
iii) Reversal of TCA cycle towards production of malate and fumarate in both scenarios: A back flux in TCA cycle, from oxaloacetate to fumarate was also observed in experiments, in both cultured astrocytes and in in-vivo conditions, which was due to the activity of mitochondrial pyruvate carboxylase. Through the model simulation, similar properties in the glioblastoma scenario were observed too (FIG. 6D). The flux through the fumarate hydratase (FUMH) and malate dehydrogenase (MDH) reactions was reversed and enhanced in the glioblastoma scenario. The reason for this reversal was to maximize succinate production through TCA cycle, which was an important component of the metabolic demand reaction.

### Example 8

### Chemotherapeutic Intervention in Glioblastoma Metabolism

The reaction knockout analysis predicted a subset of reactions which were crucial in glioblastoma growth. To identify the feasibility of targeting these reactions and their effectiveness, these reactions were simulated for their effect as chemotherapeutics for inhibiting or reducing growth rate of glioblastoma cells to a normal range. For this analysis, previously identified growth reducer reactions leading to reduced growth (0<GBM_BM solution<glioblastoma optimum) were chosen.

From simulation studies it was observed that in order to completely reduce the flux through the metabolic function, targeting the lethal single knockout reactions required a complete reduction of flux through them i.e. fluxes are required to be constrained to zero. Targeting the lethal double knockout reactions were observed to be more effective, as partial reduction of flux through those combinations brought a complete reduction of flux through the metabolic demand reaction. As such, combinations from non-trivial lethal knockout reactions were simulated which could be targeted most effectively for efficient growth reduction.

Accordingly, of the 41 non-trivial lethal double knockout predictions, 36 combinations were chosen for determining their chemotherapeutic intervening properties, which excluded a few transport reactions. Each reaction combination was simulated by varying the flux through individual reactions of the combination simultaneously, to obtain effective reduction of flux through both of these reactions which reduced glioblastoma growth completely and to obtain a feasible flux range through both the reactions for which growth rate was reduced to a normal level. The effective reduction of flux was depicted in percentage, which was defined as percentage reduction of flux through any particular reaction. The simulation results for the 10 most effective combinations have been depicted as contour plots in FIG. 9 and the rest of the 26 combinations have been also been analysed. (Data not shown) The percentage reduction of flux value for complete reduction of growth and for Normal growth, for each reaction of the combinations has been listed in the following Table 5.

TABLE 5
Percentage reduction of flux through combinatorial reaction targets.

| | Percentage reduction | | Percentage reduction | |
|---|---|---|---|---|
| | of flux for complete | | of flux for | |
| Reaction Combination | reduction of growth | | Normal growth | |
| HEX + FBA | HEX | FBA | HEX | FBA |
| | 85-100% | 95-100% | 10-40% | 15-60% |
| RPE + 6PGLase | RPE | 6PGLase | RPE | 6PGLase |
| | 80-100% | 50-100% | 15-35% | 10-100% |
| FUMH + AKGDH | FUMH | AKGDH | FUMH | AKGDH |
| | 60-100% | 70-100% | 25-65% | 5-55% |
| Trans_Glycine + PGDH | Trans_Glycine | PGDH | Trans_Glycine | PGDH |
| | 80-100% | 80-100% | 10-55% | 10-100% |
| TPI + HEX | TPI | HEX | TPI | HEX |
| | 80-100% | 85-100% | 10-60% | 15-40% |
| Trans_Glucose + GAPDH | Trans_Glucose | GAPDH | Trans_Glucose | GAPDH |
| | 85-100% | 85-100% | 10-40% | 15-55% |
| PFK + HEX | PFK | HEX | PFK | HEX |
| | 80-100% | 85-100% | 15-55% | 15-45% |
| SCS + FUMH | SCS | FUMH | SCS | FUMH |
| | 70-100% | 65-100% | 25-55% | 10-60% |
| RPE + G6PDH | RPE | G6PDH | RPE | G6PDH |
| | 80-100% | 50-100% | 15-35% | 10-100% |
| Trans_Glucose + PGK | Trans_Glucose | PGK | Trans_Glucose | PGK |
| | 85-100% | 85-100% | 10-30% | 45-55% |

Percentage of flux reduction required through each reaction of combinatorial target for complete reduction of growth and for Normal growth, as inferred from the contour plots depicted in FIG. 8.

In-silico study on the core metabolism in cancer cells showed that reactions of glycolytic, TCA cycle, oxidative phosphorylation and pentose phosphate pathway could be good targets to check cancer cell progression. But, the present context-specific constraint based metabolic model specific to glioblastoma could identify reactions belonging to cysteine metabolism and reaction combinations of glycine-serine pathway to be potential targets for controlling glioblastoma growth. These potent reaction pairs of the glycine-serine metabolism give way to discovery/formulation of combinatorial drugs that can inhibit them. Therapeutic agents to target the glycine receptors are already known. Inhibitors like Picrotoxin targeted the neuronal γ-aminobutyric acid and homomeric glycine receptors, whereas strychnine hydrochloride was found to be a potent antagonist specific to the glycine receptor. These could be employed beneficially to understand the activity of the glycine transporters in glioblastoma too, as evidences state a correlation between the glycine transporter activities with the distribution of its receptors. In recent years, many pharmaceuticals have also developed potent and selective inhibitors for glycine transporters. SSR 504734 and SSR 103800, a series of N-(2-aryl-cyclohexyl) substituted spiropiperidines and ORG 25935 are a few compounds which showed promising results as inhibitors of glycine transporters.

### ADVANTAGES OF THE INVENTION

The present invention provides a varied range of metabolic targets, target combinations to treat Glioblastoma as per the necessary requirement.
Combinatorial targeting of glycine transporter with any other reaction belonging to the glycine-serine metabolism proved lethal to glioblastoma growth.
The present invention determines essential metabolites and metabolite reactions that cause glioblastoma growth.

We claim:

1. An in-silico method for identifying essential metabolite and combinatorial target reaction associated with inhibition or suppression of glioblastoma cell growth, comprising:
(a) providing data retrieved from biological database and literature relating to reactions in metabolic pathways associated with glioblastoma metabolism to construct an astrocyte/glioblastoma metabolism model in a computer readable storage medium;
(b) simulating the model obtained in step (a) by constraining fluxes through said reactions in metabolic pathways as per reversibility and irreversibility of reactions, wherein reversible reactions were bound in range of v_{lb}=−1000 and v_{ub}=1000 and for irreversible reactions the model is bound either from 0 to 1000 or 1000 to 0;
(c) defining at least one flux distribution that increases or decreases the objective functions defined for the network, one of which accounts for the ATP requirement of the network and the other comprising ribose-5-phosphate (r5p), oxaloacetate (oaa), succinate (succ) and glutathione (glt), when a constraint is applied to the astrocyte/glioblastoma metabolism model, wherein said objective functions comprises
(i) ATP synthesis through oxidative phosphorylation (ATPSyn)
ATPSyn=adp[m]+pi[m]+4 h+[i]->h2o[m]+atp[m]+3 h+[m] [Eq. (i)]
(ii) a metabolic demand reaction:
GBM_BM=oaa[m]+glt[c]+r5p[c]+succ[m] [Eq. (ii)];
(d) identifying essential metabolite selected from the group consisting of cysteine metabolism, glycine-serine metabolism, glutathione metabolism, and glycolysis contributing to the increase in objective function, thereby contributing to growth of glioblastoma; and
(e) perturbing the glioblastoma model by performing single knockout analysis of all reactions of step (d) present within the model, and by performing double knockout analysis to identify a combination of glycine transporters and/or one or more enzymes catalyzing the reaction of glycine-serine metabolism inhibiting glioblastoma growth.

2. The method as claimed in claim 1, wherein enzyme of the cystine-glutathione metabolism identified are selected from the group consisting of Cystine glutamate antiporter, cystine reductase (CystRed), Glutamate-cysteine ligase (GCL), and Glutathione synthase.

3. The method as claimed in claim 1, wherein one or more enzyme catalyzing the glycine serine metabolism are selected from the group consisting of Phosphoglycerate dehydrogenase (PGDH), Glycine hydroxymethyl transferase (GHMT), Phosphoserine phosphatase (PSP), and Phosphoserine transaminase (PST).

4. The method as claimed in claim 1, wherein other enzyme is selected from reactions of glycolysis, glutathione metabolism and pentose phosphate pathway.

5. The method as claimed in claim 4, wherein enzyme is selected from the group consisting of α-ketoglutarate dehydrogenase (AKGDH), glucose transporters, glycine transporter, 6-phosphogluconolactone dehydrogenase (PGCDH), Glucose-6-phosphate dehydrogenase (G6PDH), and Transketolase 1 (TK1).

6. The method as claimed in claims 1 to 5, wherein perturbing glycine transporter in combination with one or more enzyme catalyzing the reaction of glycine-serine metabolism inhibiting glioblastoma growth in the range of 20% to 100%.

7. A method of inhibiting the growth of glioblastoma in subject suffering for same by inhibiting the functioning of one or more enzyme catalyzing cysteine and glutathione metabolism and/or inhibiting a combination of glycine transporter with one or more enzyme catalyzing glycine-serine metabolism.

8. The method as claimed in claim 7, wherein enzyme of the cystine-glutathione metabolism identified are selected from the group consisting of Cystine glutamate antiporter, cystine reductase (CystRed), Glutamate-cysteine ligase (GCL), and Glutathione synthase.

9. The method as claimed in claim 7, wherein a combination of glycine transporter along with one or more enzyme catalyzing the glycine serine metabolism is selected from the group consisting of Phosphoglycerate dehydrogenase (PGDH), Glycine hydroxymethyl transferase (GHMT), Phosphoserine phosphatase (PSP), and Phosphoserine transaminase (PST).
